(19) United States
(12) Patent Application Publication
(10) Pub. No.: US 2026/0195863 A1
(43) Pub. Date: Jul. 9, 2026

(54) SYSTEMS, APPARATUSES, METHODS, AND NON-TRANSITORY COMPUTER-READABLE STORAGE DEVICES FOR VIDEO PROCESSING

(71) Applicant: HUAWEI TECHNOLOGIES CO., LTD., Shenzhen (CN)

(72) Inventors: Muhammad Kamran Janjua, Edmonton (CA); Amirhosein Ghasemabadi, Edmonton (CA); Mohammad Salameh, Edmonton (CA); Di Niu, Edmonton (CA)

(21) Appl. No.: 19/010,681

(22) Filed: Jan. 6, 2025

(51) Int. Cl. G06T 5/60; G06T 7/246

(52) U.S. Cl. CPC G06T 5/60; G06T 7/246; G06T 2207/10016; G06T 2207/20021; G06T 2207/20081; G06T 2207/20084

(57) ABSTRACT

Embodiments of the present application provide a computerized video processing method, comprising obtaining an input frame from a video for restoration; and processing the input frame to generate an output frame using a neural-network-based machine learning model. The machine learning model is based on an encoder-decoder architecture comprising at least one memoryless encoder and at least one decoder. At least one degradation contained in the input frame is restored using the at least one decoder, based on the input frame and a history of the input frame, the history of the input frame comprising a sequence of frames of the video preceding the input frame of up to a first predetermined number.

### FIELD OF THE DISCLOSURE

The present disclosure generally relates to systems, apparatuses, methods, and non-transitory computer-readable storage media, and in particular to systems, apparatuses, methods, and non-transitory computer-readable storage media for video processing.

### BACKGROUND

Video degradation refers to a perceived reduction or corruption in the quality of a video. The degradation can be induced by camera sensors (high ISO in low-light), or external factors (such as rain, snow, haze, etc.). Video processing and restoration finds its wide-spread applications in video streaming, surveillance, medicine, autonomous vehicles, consumer photo/videography, and the like, aiming to repair or restore the quality of the video, particularly in degradation inducing environments.

Many video processing and/or restoration methods have been proposed and revolutionized by the development of artificial intelligence and neural networks. However, existing machine-learning-based video processing methods generally require huge computational resources to effectively restore the videos. They also often lack the ability to process the video efficiently in real time as the video arrives. Efficient video restoration or processing architectures enable digital photography on resource-constrained consumer devices. However, designing a general video restoration or processing method is highly challenging due to motions affecting video qualities and hindering borrowing information across frames.

Accordingly, there is still a desire for a solution that addresses some of the challenges of the existing machine-learning-based video processing methods.

### SUMMARY

According to one aspect of this disclosure, there is provided a computerized video processing method, comprising obtaining an input frame from a video for restoration; and processing the input frame to generate an output frame using a neural-network-based machine learning model, wherein the machine learning model is based on an encoder-decoder architecture comprising at least one memoryless encoder and at least one decoder. Processing the input frame to generate the output frame comprises processing the input frame using the at least one memoryless encoder to extract features from the input frame; restoring at least one degradation contained in the input frame using the at least one decoder, based on the input frame and a history of the input frame, the history of the input frame comprising a sequence of frames of the video preceding the input frame of up to a first predetermined number; and generating the output frame with restored degradation.

In some embodiments, restoring at least one degradation contained in the input frame comprises generating a motion compensated history of the input frame, based on the input frame and the history of the input frame.

In some embodiments, the input frame comprises a plurality of first regions, and generating the motion compensated history of the input frame comprises for each first region of the input frame, searching for at least one second region most relevant to the corresponding first region in the history of the input frame; and generating the motion compensated history of the input frame based on a correspondence between each first region and the corresponding at least one second region.

In some embodiments, searching for the at least one second region is based on a top-k search of a maximum of k regions in the history of the input frame for the at least one second region most relevant to each first region.

In some embodiments, restoring at least one degradation contained in the input frame further comprises assigning weights to the motion compensated history of the input frame, based on an importance of a corresponding frame in the motion compensated history of the input frame to the input frame; and calculating a weighted sum of the motion compensated history of the input frame for generating the output frame.

In some embodiments, the machine learning model is based on a U-Net structure.

In some embodiments, each of the at least one encoder comprises at least one feed forward network (FFN).

In some embodiments, the first predetermined number is 3.

In some embodiments, the machine learning model is trained though operations comprising obtaining a training video; dividing the training video into a plurality of clips, each clip comprising a second predetermined number of training frames; processing two or more clips using two or more decoders in parallel; and resetting a state of each decoder once the processing of a corresponding clip is completed.

In some embodiments, the method further comprises continuously processing each frame of the video for restoration without resetting a state of the at least one decoder.

According to one aspect of this disclosure, there is provided an apparatus for video processing, comprising at least one processor; and a non-transitory computer-readable storage medium coupled to the at least one processor and recorded thereon computer-readable instructions for execution by the at least one processor. The instructions, when executed by the at least one processor, configures the apparatus to carry out a computerized method comprising obtaining an input frame from a video for restoration; and processing the input frame to generate an output frame using a neural-network-based machine learning model, wherein the machine learning model is based on an encoder-decoder architecture comprising at least one memoryless encoder and at least one decoder. Processing the input frame to generate the output frame comprises: processing the input frame using the at least one memoryless encoder to extract features from the input frame; restoring at least one degradation contained in the input frame using the at least one decoder, based on the input frame and a history of the input frame, the history of the input frame comprising a sequence of frames of the video preceding the input frame of up to a first predetermined number; and generating the output frame with restored degradation.

In some embodiments, restoring at least one degradation contained in the input frame comprises generating a motion compensated history of the input frame, based on the input frame and the history of the input frame.

In some embodiments, the input frame comprises a plurality of first regions, and generating the motion compensated history of the input frame comprises for each first region of the input frame, searching for at least one second region most relevant to the corresponding first region in the history of the input frame; and generating the motion compensated history of the input frame based on a correspondence between each first region and the corresponding at least one second region.

In some embodiments, searching for the at least one second region is based on a top-k search of a maximum of k regions in the history of the input frame for the at least one second region most relevant to each first region.

In some embodiments, restoring at least one degradation contained in the input frame further comprises assigning weights to the motion compensated history of the input frame, based on an importance of a corresponding frame in the motion compensated history of the input frame to the input frame; and calculating a weighted sum of the motion compensated history of the input frame for generating the output frame.

In some embodiments, the machine learning model is based on a U-Net structure.

In some embodiments, each of the at least one encoder comprises at least one feed forward network (FFN).

In some embodiments, the first predetermined number is 3.

In some embodiments, the machine learning model is trained though operations comprising obtaining a training video; dividing the training video into a plurality of clips, each clip comprising a second predetermined number of training frames; processing two or more clips using two or more decoders in parallel; and resetting a state of each decoder once the processing of a corresponding clip is completed.

In some embodiments, the non-transitory computer-readable storage medium records thereon computer-readable instructions that, when executed by the at least one processor, cause the apparatus to continuously processing each frame of the video for restoration without resetting a state of the at least one decoder.

According to one aspect of this disclosure, there are provided one or more non-transitory computer-readable storage devices comprising computer-executable instructions for execution by at least one processor, wherein the instructions when executed by the at least one processor, cause the at least one processor to perform operations comprising obtaining an input frame from a video for restoration; and processing the input frame to generate an output frame using a machine learning model, wherein the machine learning model is based on an encoder-decoder architecture comprising at least one memoryless encoder and at least one decoder, and each of the at least one memoryless encoder and the at least one decoder comprises one or more neural networks. Processing the input frame to generate the output frame comprises processing the input frame using the at least one memoryless encoder to extract features from the input frame; restoring at least one degradation contained in the input frame using the at least one decoder, based on the input frame and a history of the input frame, the history of the input frame comprising a sequence of frames of the video preceding the input frame of up to a first predetermined number; and generating the output frame with restored degradation.

The various embodiments disclosed herein provide a general machine-learning-based video processing or restoration method and system, suitable for resource-constrained consumer devices. The procedure and methodology described in various embodiments exploits an encoder-decoder architecture where the encoder stage is historyless and the decoder stage conditions the restoration on a history of the input frame. The explicit history maintained in the system is truncated to a limited number of history frames. The described video processing method and system is computationally friendly and can process and restore degraded videos effectively and efficiently (including online applications), which makes the solution desirable for a variety of applications and edge devices, such as smartphone cameras, action cameras, commercial photography and/or videography devices, unmanned aerial vehicles (UAVs), autonomous vehicles, and the like.

### BRIEF DESCRIPTION OF THE DRAWINGS

These and other features of the disclosure will become more apparent from the description in which reference is made to the following appended drawings.

FIG. 1 is a schematic diagram showing a simplified infrastructure of a system implementing a video processing method, according to some embodiments of this disclosure;

FIG. 2 is a schematic diagram showing an example structure of the computation module, according to some embodiments of this disclosure;

FIG. 3 is a schematic diagram of a neural network, according to some embodiments of this disclosure;

FIG. 4 is a schematic diagram showing a simplified hardware structure of an example execution device 150, according to some embodiments of this disclosure;

FIG. 5 is a schematic diagram of an example hardware architecture of the processor in FIG. 4;

FIG. 6 is a schematic diagram of a structure of a video processing system, according to some embodiments of this disclosure;

FIG. 7 is a schematic diagram of a structure of an exemplary encoder, according to some embodiments of this disclosure;

FIG. 8 is a schematic diagram of a structure of the causal history model (CHM), according to some embodiments of this disclosure;

FIG. 9(A) is a schematic diagram of a training view of the CHM, according to some embodiments of this disclosure;

FIG. 9(B) is a schematic diagram of an inference view of the CHM, according to some embodiments of this disclosure;

FIG. 10 is a flowchart showing operations of a method of a video processing method, according to some embodiments of this disclosure;

FIG. 11 is a flowchart showing operations of restoring at least one degradation contained in the input frame, according to some embodiments of this disclosure; and

FIG. 12 is a flowchart showing operations of a method of training the machine learning model, according to some embodiments of this disclosure.

### DETAILED DESCRIPTION

Embodiments disclosed herein relate to systems, apparatuses, methods, and non-transitory computer-readable storage media for video processing. The described embodiments provide a general machine-learning-based video processing or restoration method and system, suitable for resource-constrained consumer devices. The procedure and framework described in various embodiments exploits an encoder-decoder architecture where the encoder stage is historyless and the decoder stage conditions the restoration on a history of the input frame. The explicit history maintained in the system is truncated to a limited number of history frames.

The described video processing method and system is computationally friendly and can process and restore degraded videos effectively and efficiently, suitable for online applications where the frames are processed as they are registered/arrive. This makes the solution desirable for various, sometimes task-specific restorations and edge devices.

The described embodiments of apparatuses, methods, and systems can be used in applications such as video streaming (for video platforms), consumer cameras (for camera and smartphone manufacturers), action cameras (for action camera manufacturers), autonomous vehicles (to process videos captured on the go for security, safety, and interpretable decision making), unmanned aerial vehicles (UAVs) (for UAV manufacturers to capture high-quality footage), surveillance (for closed-circuit television (CCTV) manufacturers), and even digital pathology where capturing high-quality videos are necessary to make a clinical decision accurately.

### A. System Structure

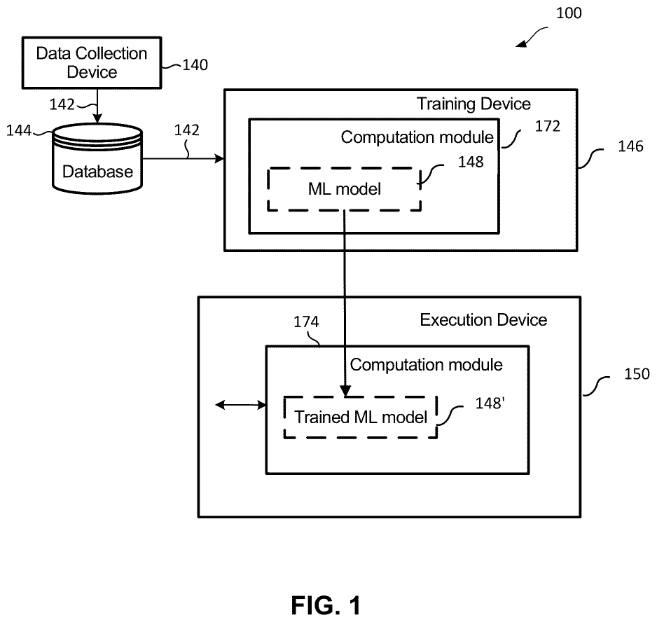

FIG. 1 is a schematic diagram showing a simplified infrastructure of a system 100 implementing a video processing method, according to some embodiments of this disclosure. As shown, the system 100 can comprise a data collection device 140 for collecting training data 142 (e.g., training videos) for training a machine learning model 148 comprising at least one neural network. The collected training data 142 can be stored in a training database 144. Herein, the training data 142 comprises a plurality of identified, annotated, or otherwise classified data samples, such as one or more frames, video clips, or videos, that may be used for training a corresponding application or specific usage. The desired results are ideal results expected to be obtained by processing the training video using the trained or optimized machine learning model 148′, e.g., for at least one application, or for a particular type of degradation.

One or more training devices 146 (e.g., one or more server computers forming the so-called “computer cloud” or simply the “cloud”) can comprise a computation module 172 which is utilized to train the machine learning model 148. The computation module 172 uses the training data 142 retrieved from the training database 144 to obtain the trained machine learning model 148′ for use by the execution device 150.

As those skilled in the art will appreciate, in actual applications, the training data 142 maintained in the training database 144 may not necessarily be all collected by the data collection device 140, and may be received from other devices. Moreover, the training devices 146 may not necessarily perform training completely based on the training data 142 maintained in the training database 144 to obtain the trained machine learning model 148′, and may obtain training data 142 from a cloud or another place to perform model training.

The video processing framework and the video processing method provided in the embodiments of this disclosure are applicable to various terminals, which may be referred to as “execution devices”, or“edge devices”. Correspondingly, the trained machine learning model 148′ obtained by the training devices 146 through training may be applied to various systems, applications, or devices such as an execution device 150 implemented on a mobile phone, a tablet, a computer, a consumer-grade camera, an action camera, or other high-speed motion capturing device, an autonomous vehicle, an UAV, a robot, an augmented reality (AR) device, a virtual reality (VR) device, a wearable device, a server, or the like. The execution device 150 obtains the trained machine learning model 148′ and implements a computation module 174 which uses the trained machine learning model 148′ to analyze received data, such as a raw frame, video or video clip, for video processing or restoration. As described above, the results from the computation module 174, such as a restored frame or video, may be output to a display, transmitted externally, or stored in a memory.

Each computation module 172, 174 can comprise a processor suitable for large-scale exclusive OR operation processing, for example, a neural-network processing unit (NPU), a tensor processing unit (TPU), a graphics processing unit (GPU), or the like. The computation module 174 may be part of the execution device 150 coupled to a host central processing unit (CPU) for use as the computational module 174 under the control of the host CPU.

Herein, training refers to the process of feeding representative training datasets to the machine learning model 148 and allowing the machine learning model 148 to learn patterns from the training datasets to adjust model parameters iteratively to optimize performance. The result of a training stage of a machine learning model 148 is a trained machine learning model 148′.

The training process can be repeated several times during and/or in between deployments, for example, when the use application changes, or if the nature of the representative training datasets changes. For example, a machine learning model 148 may be trained for video processing for rain induced degradations and retrained for snow induced degradations. The representative training datasets may be chosen depending on the specific usage or application of the machine training model 148′.

Inference refers to the process of using a trained machine learning model 148′ to make predictions or decisions based on new, unseen data. In the case of video processing, the inference stage refers to the stage of generating repaired data from the input raw data, based on predictions and/or decisions.

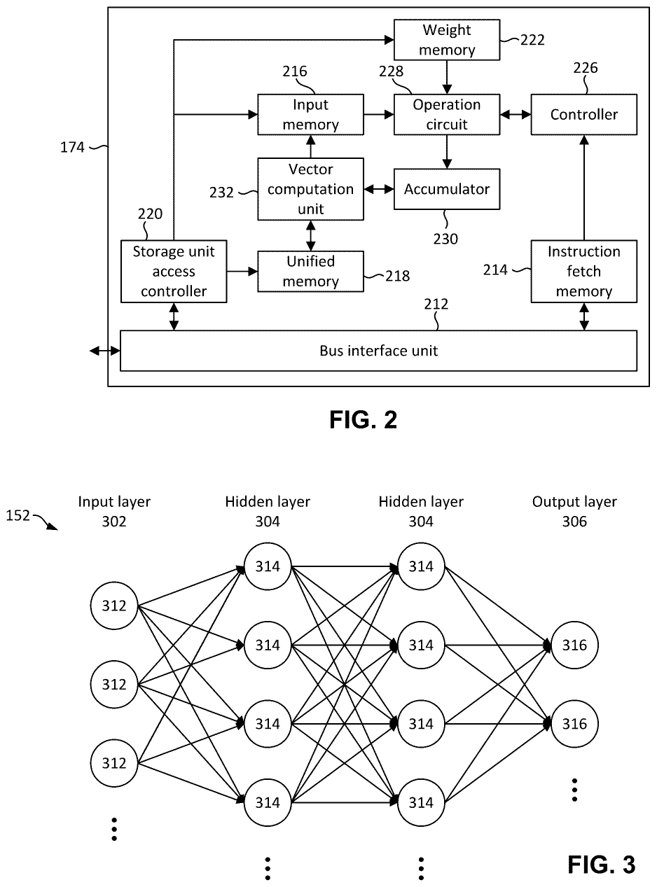

FIG. 2 is a schematic diagram showing an example structure of the computation module 174, according to some embodiments of this disclosure.

As shown in FIG. 2, the computational module 174 may obtain instructions and data (such as input data and weight data) externally via a bus interface unit (BIU) 212. The instructions are transferred to an instruction fetch buffer 214. The input data is transferred to an input memory 216 and a unified memory 218 via a storage-unit access controller (or a direct memory access controller, DMAC) 220, and the weight data is transferred to a weight memory 222 via the DMAC 220. In these embodiments, the instruction fetch buffer 214, the input memory 216, the unified memory 218, and the weight memory 222 are on-chip memories, and the input data and the weight data may be organized in matrix forms (denoted “input matrix” and “weight matrix”, respectively).

A controller 226 obtains the instructions from the instruction fetch buffer 214 and accordingly controls an operation circuit 228 to perform multiplications and additions using the input matrix from the input memory 216 and the weight matrix from the weight memory 222.

In some implementations, the operation circuit 228 comprises a plurality of processing engines (PEs; not shown). In some implementations, the operation circuit 228 is a two-dimensional systolic array. The operation circuit 228 may alternatively be a one-dimensional systolic array or another electronic circuit that may perform mathematical operations such as multiplication and addition. In some implementations, the operation circuit 228 is a general-purpose matrix processor.

For example, the operation circuit 228 may obtain an input matrix A (for example, a matrix representing an input frame) from the input memory 216 and a weight matrix B (for example, a convolution kernel) from the weight memory 222, buffer the weight matrix B on each PE of the operation circuit 228, and then perform a matrix operation on the input matrix A and the weight matrix B. The partial or final computation result obtained by the operation circuit 228 is stored into an accumulator 230.

If required, the output of the operation circuit 228 stored in the accumulator 230 may be further processed by a vector calculation unit 232 such as vector multiplication, vector addition, an exponential operation, a logarithmic operation, size comparison, and/or the like. The vector calculation unit 232 may comprise a plurality of operation processing engines, and is mainly used for calculation at a non-convolutional layer or a fully connected layer (FC) of the convolutional neural network, and may specifically perform calculation in pooling, normalization, and the like. For example, the vector calculation unit 232 may apply a non-linear function to the output of the operation circuit 228, for example a vector of an accumulated value, to generate an active value. In some implementations, the vector calculation unit 232 generates a normalized value, a combined value, or both a normalized value and a combined value.

In some implementations, the vector calculation unit 232 stores a processed vector into the unified memory 218. In some implementations, the vector processed by the vector calculation unit 232 may be stored into the input memory 216 and then used as an active input of the operation circuit 228, for example, for use at a subsequent layer in the convolutional neural network.

The data output from the operation circuit 228 and/or the vector calculation unit 232 may be transferred externally.

FIG. 3 is a schematic diagram of a neural network 152 which can be a unit of the machine learning model 148, 148′. The trained machine learning model 148′ generally has the same structure as the machine learning model 148 but may have a different set of parameters. As shown, the neural network 152 can comprise an input layer 302, a plurality of cascaded hidden layers 304, and an output layer 306.

The input layer 302 comprises a plurality of input nodes 312 for receiving input data and outputting the received data to the computation nodes 314 of the subsequent hidden layer 304. Each hidden layer 304 comprises a plurality of computation nodes 314. Each computation node 304 weighs and combines the outputs of the input or computation nodes of the previous layer (that is, the input nodes 312 of the input layer 302 or the computation nodes 314 of the previous hidden layer 304, and each arrow representing a data transfer with a weight). The output layer 306 also comprises one or more output node 316, each of which combines the outputs of the computation nodes 314 of the last hidden layer 304 for generating the outputs 356.

As those skilled in the art will appreciate, the neural network 152 shown in FIG. 3 generally requires training for optimization. For example, a training device 146 (see FIG. 2) may provide training data 142 (which comprises a plurality of training samples for a corresponding application) to the input nodes 312 to run through the neural network 152 and generate outputs from the output nodes 316. By comparing the output obtained from the output nodes 316 with desired results, a cost function may be established and the parameters of the neural network 152, such as the weights thereof, may be optimized by minimizing the cost function.

Training a machine learning model requires large number of iterations. Thus, the training process is usually conducted by one or more training devices 146 (such as computer servers or computer cloud). On the other hand, the trained model may be deployed in one or more execution devices 150 (also denoted as “edge devices”). Compared to the edge devices 150, the cloud or servers 146 usually have virtually unlimited computational power and/or space for training the machine learning model. On the other hand, the edge devices 150 usually have strict constraints on memory/latency. Consequently, there may exist some difficulties to deploy the machine learning model to the edge devices 150.

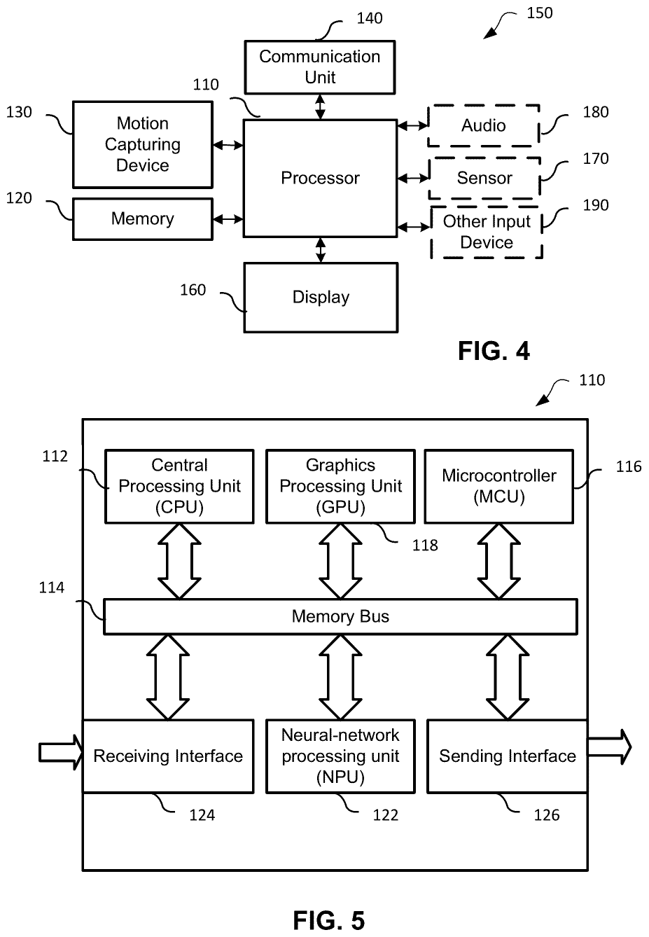

FIG. 4 is a schematic diagram showing a simplified hardware structure of an example execution device 150 according to some embodiments of this disclosure. The example execution device 150 can include a processor 110, a memory 120, a motion capturing device 130, a communication unit 140 and a display 160. The example execution device 100 may further comprise one or more sensors 180, an audio 180, and/or other input device 190.

The processor 110 is configured for performing various processing operations such as signal coding, data processing, power control, input/output processing, or any other functionalities. The processor 110 may include various general-purpose processing devices, for example, may be a general-purpose CPU, a system on chip (SOC), a processor integrated on a SOC, a separate processor chip, or a controller. The processor 130 may further include a dedicated processing device, such as an application specific integrated circuit (ASIC), a field programmable gate array (FPGA), a digital signal processor (DSP), a dedicated video or graphics processor, a GPU, and/or an NPU. The processor 130 may be a processor group including at least one processor, and the at least one processor is coupled to each other through one or more buses. The processor may include an analog-to-digital converter (ADC) and a digital-to-analog converter (DAC) to implement a signal connection between different components of the apparatus. The processor 130 is configured to process image, audio, video, and other media signals. The processor 110 may further include a communications processor configured to receive and send signals by using the communication unit 140. The signals may be media signals, voice signals, or control signals.

Examples of the processor 110 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processor 110 may execute computer-executable instructions or code stored in the memory 120 to perform various processes described herein.

The memory 120 may be coupled to the processor 110 by using one or more memory controllers. The memory 120 is configured for storing instructions executable by the processor 110 and data used, generated, or collected by the processor 110. For example, the memory 120 may be configured to store computer program instructions, including a computer operating system (OS) and various user application programs. The processor 110 may read a computer program instruction from the memory 120, or store a computer program instruction in the memory 120, to implement a related processing function. For example, the memory may store instructions of software, software systems, or software modules that are executable by the processor 110 for implementing some or all of the functionalities and/or embodiments of the video processing system described herein.

By way of example, and not limiting, the memory can embody computer-readable storage media comprising random-access memory (RAM), read-only memory (ROM), electrically erasable programmable read-Only memory (EEPROM), compact disc (CD)-ROM or other optical disk storage, magnetic disk storage, or other magnetic storage devices, flash memory, or any other medium that can be used to store desired program code in the form of instructions or data structures and that can be accessed by a computer. Further, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes CD, laser disc, optical disc, digital versatile disc (DVD), floppy disk and Blu-ray disc, where disks usually reproduce data magnetically, while discs reproduce data optically with lasers. Combinations of the above should also be included within the scope of computer-readable media. The memory 120 may exist independently, or the memory 140 may be integrated with the processor 110.

The example execution device 150 may be further equipped with at least one motion capturing device 130 configured to collect or capture motions and/or videos, and may be triggered by an application instruction, to implement a recording function, for example, for obtaining a video, A specific quantity of motion capturing devices and their arrangement may be flexibly depending on a requirement or a policy of a manufacturer, Examples of the motion capturing device 130 include but are not limited to smartphone cameras, consumer-grade cameras, or specialized cameras used for specific applications, such as under-water cameras, cameras for an automative vehicle or an UAV, or cameras for other high-speed applications.

The example execution device 150 may further comprise a communication unit 140 for communication with other devices and/or networks. The communication unit 140 may be coupled to one or more antennas, or an antenna array including a plurality of antennas for transmission through wireless communications. The communication unit 140 may provide a wireless connection capability to another device. The another device may be a peripheral device such as a wireless network, such as a Wi-Fi® network (WI-FI is a registered trademark of Wi-Fi Alliance, Austin, TX, USA), a wireless personal area network (WPAN), or another wireless local area network (WLAN). For example, the communication unit 140 may be embedded with a Wi-Fi compatible functionality, configured to wirelessly couple the processor 130 to a wireless network or another device.

The communication unit 140 may be further configured for communicating with other devices via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

The execution device 150 may also include one or more sensors 170. Examples of the sensor 170 include but are not limited to an image sensor, a motion sensor, a proximity sensor, an ambient noise sensor, a sound sensor, an accelerometer, a temperature sensor, a gyroscope, or other types of sensors, and various combinations thereof.

Other input devices 190 may be coupled to the processor 110 for receiving various other inputs, such as user inputs. Examples of the other input devices 190 may include but not limited to a keyboard, a physical button (a press button, a rocker button, or the like), a dial, a slide switch, a joystick, a click wheel, an optical mouse (the optical mouse is a touch-sensitive surface that does not display a visual output, or an extension of a touch-sensitive surface formed by a touchscreen), or the like.

The execution device 150 may comprise at least one I/O subsystem (not shown) for controlling the communication between various components of the device and/or the processor 110.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

It should also be understood that the execution device 150 in FIG. 4 is merely a simplified example, and a specific form of the device 150 depends on the specific type of the device and the application of the device. The execution device 150 can further include components not shown in FIG. 4.

FIG. 5 is a schematic diagram of an example hardware architecture of the processor 110 in FIG. 4. The video processing method and the video processing framework described in various embodiments of this disclosure may be applied to the processor 110, such as a processor chip.

Referring to FIG. 5, the processor 110 may include a CPU 112, a memory bus 114, a microcontroller unit (MCU) 116, a GPU 118, a NPU 122, a receiving interface 124, a sending interface 126, and the like. Although not shown in FIG. 5, the processor 110 may further include an application processor (AP), and a dedicated video or image processor.

The parts of the processor 110 can be coupled by using a connector. For example, the connector includes various interfaces, transmission lines, buses, or the like. Non-limiting examples of these interfaces generally include electrical communication interfaces, and may alternatively be mechanical interfaces or interfaces in other forms.

Optionally, the CPU may be a single-core processor (single-CPU) or a multi-core processor (multi-CPU). The CPU may be a processor group including at least one processor, and the at least one processor is coupled to each other by using one or more buses. The receiving interface may be a data input interface of the processor chip. In some implementations, the receiving interface and the sending interface may be a high-definition multimedia interface (HDMI), a V-By-One interface, an embedded display port (eDP), a mobile industry processor interface (MIPI), a Display Port (DP), or the like.

The various parts may be integrated into one chip. Alternatively, the CPU, the GPU, the receiving interface, and the sending interface may be integrated into one chip, and each part in the chip accesses an external memory through using a bus. Concurrently or alternatively, the dedicated video/graphics processor and the CPU may be integrated on one chip, or may exist as independent processor chips. If applicable, the NPU configured to implement various operations related to a neural network or deep learning may also be an independent processor chip. In some embodiments, the described video processing method and the video processing framework may be implemented by the GPU, the NPU, the dedicated graphics processor, or some of these parts combined.

### B. Video Restoration

Video restoration refers to recovering a video by undoing the process that afflicts degradations in a video (for example, noise, rain, haze, snow, etc.). These degradations can either be induced by camera sensors (e.g., high ISO in low-light), or caused by external factors (e.g., rain, snow, haze, etc.). Video restoration aims to repair or recover the corrupted video of potential degradations and finds its wide-spread usage in a variety of different applications including but not limited to video streaming, surveillance, medical imaging, autonomous vehicles, consumer photo/videography, and the like.

In principle, an important factor affecting the video other than degradation is motion. Motion affects the entire trajectory of the video non-uniformly at pixel level. This hinders any effective borrowing of information across frames, given the existence of pixel misalignment due to motion. Accordingly, motion compensation needs to be taken into consideration to properly restore the video. Often, certain regions in the input frame could potentially be occluded due to degradations, and the same regions in neighboring frames could be utilized to effectively restore the video, if motion is compensated for in the frames.

Video processing methods or systems can be categorized based on the different ways to provide video restoration and motion compensation.

For example, methods for video processing can opt for recurrence or parallelism as their ways to process the degraded videos.

In recurrent methods, also referred to as recurrent neural networks (RNNs), certain parts of the neural network (or even the entire neural network) can be re-used to process several frames, allowing parameter-saving. RNNs process the data by maintaining a hidden state that carries information from one or more previous time stamps. The RNNs update the hidden state with each new input, allowing them to capture long-term dependencies.

States refers to a collection of information that represents the current status of the system at a given moment. In the context of RNNs, the state can be called a hidden state, which serves as a form of memory that captures historical information from previous time steps. The recurrent connection allows the network to retain information over time, for processing sequential or time-dependent data.

In contrast, parallel methods may stack several backbone feature extractors to process frames in a sliding window fashion. Sliding window processing separates sequential data into chunks or “windows” that move across a larger dataset and can be an efficient technique for handling continuous data streams in a distributed computing environment. This allows for the grouping of events within a dynamic interval that moves over time.

Parallel methods provide faster speeds in training since they can parallelize training on multiple processors (such as GPUs), while recurrent methods benefit in inference since they can consider longer frame context.

Motion refers to the transformation of a current frame in relation to a reference frame. Motion compensation allows accounting for the motion between two frames to provide the estimation of a frame. Once motion is compensated for between frames, borrowing information across multiple frames for video restoration becomes feasible. This can be best exploited in video restoration since the estimated frame contains one-to-one correspondence of regions between a frame under restoration and a reference frame, and the frame under restoration can borrow this information from the reference frame for video restoration. The borrowed information (e.g., the one-to-one correspondence) can be important to video restoration since it might be the case that some region is occluded due to degradation in a frame, while the frame's history can prove to be helpful in restoring the same region with high perceptual quality.

Motion compensation refers to algorithmic methods that estimate a frame given the two consecutive frames by accounting for motion of the camera and/or objects in the video. Motion compensation methods can also be categorized between explicit motion compensation methods and implicit motion compensation methods.

Optical Flow, also known as optic flow, refers to a measure of apparent motion of objects, surfaces, and edges in a visual scene which is usually caused by a relative motion between an observer and a scene. In other words, optical flow measures how each of the pixels has displaced from the input frame with respect to a reference frame.

Optical flow is a traditional method to estimate and compensate for motion of two consecutive frames. However, in many real-world scenarios, especially in the case of degraded videos, classic optical flow algorithms cannot estimate motion reliably. Therefore, many contemporary methods adopt deep-learning based optical flow methods, and couple it with the video restoration method, often jointly optimizing the parameters of both the architectures of the video restoration method and the optical flow method. These methods are known as explicit motion compensation methods, since they explicitly model motion using optical flows.

The motion compensation methods can be implicit in that they do not rely on optical flows to develop a motion compensation strategy. Such approaches operate in the deep feature space in some stages of the restoration neural network, and therefore, resort to non-local searchers across the feature maps to mine for similar regions across several frames or perform feature-space temporal shift. Conventional implicit motion compensation methods are often computationally expensive, since they require searching across the entire spatial region of the input to find correspondences.

Methods for video restoration can therefore fall into various combinations of video processing and motion compensation. For example, a method may be categorized into parallel video processing and explicit motion compensation, recurrent video processing and explicit motion compensation, parallel video processing and implicit motion compensation, or recurrent video processing and implicit motion compensation.

In general, optical flow methods follow the assumption that pixel intensity remains unchanged across the neighboring frames. This assumption is violated in the case of degraded videos since degradations change the intensity of the pixels non-uniformly. Therefore, off-the-shelf optical flow algorithms on degraded videos cannot reliably predict the motion vectors. To circumvent this problem, most video restoration algorithms that depend on optical flow resort to jointly learning optical flow and restoration. For example, in explicit motion compensation methods, two sets of parameters must be optimized i.e., one for video restoration architecture, and one for optical flow. This adds additional computational burden, thereby hindering the method's ability to deploy on any resource-constrained hardware.

Several conventional video restoration methods consider neighboring frames both in the future, and in the history, often 5 to 13 frames in each case. Since observing 13 frames (or even 1 frame) requires waiting for said number of frames to arrive, methods such as these cannot restore (or process) the video online. In video streaming, online methods are of significance because they can restore the frames on the go.

Further, almost all the conventional video restoration methods require huge computational resources to restore the video. This is because they either stack several feature extractors during inference, and resort to multiple stages (typically feature fusion, and frame restoration stages) to restore a video (for parallel methods); or have an auto-regressive feature refinement stage (for recurrent methods). Further, with a sperate optical flow module, the number of parameters, as well as computational cost can increase significantly since the optical flow module cannot be decoupled from the main restoration architecture during inference.

Yet further, many of the conventional video restoration methods present results for synthesized degradations (such as synthetic blur, synthetic noise, synthetic super resolution, etc.). Lack of thorough evaluation on real-world video restoration benchmarks leads to their inability to apply to real-world degradations.

### C. Turtle

According to various embodiments of this disclosure, the video processing methods, systems, and computer readable media employ a machine learning model referred to as the truncated causal history model (“Turtle”), which is based on an encoder-decoder architecture. Turtle is a neural-network-based machine learning model comprising at least one memoryless encoder and at least one decoder. Each of the memoryless encoder and the decoder comprise one or more neural networks. One input frame is fed into the system described herein at a time and one frame is output, generated based on a history of the input frame. The history of the input frame is truncated in that only history frames of up to a first predetermined number are explicitly maintained for use in the restoration of the input frame. Turtle functions in an end-to-end manner, without resorting to any external motion compensation modules such as optical flow.

Convolutional neural network (CNN) described earlier refers to a type of neural network that can process visual data (such as images or frames). A building block for a CNN is a convolution layer which applies a set of learnable filters (also referred to as kernels) to the input data, performing a convolutional operation. Kernels are typically small matrices (e.g., 3×3) that slide across the input data, used to detect specific features or patterns in the input data. The values in kernels are the weights that the neural network learns during training. In some embodiments of this disclosure, the kernel in a 3×3 CNN layer can slide in three directions: width, height, and time (across frames). CNN layers can be used inside a Feed Forward Network (FFN).

A feature map is the output produced by applying the set of learnable filters (i.e., a matrix of weights) or feature detector to an input frame or the output of a previous layer. A feature map can represent specific features, aspects, or characteristics extracted from the input frame through convolutional operations. A feature map is an important component of the CNNs for tasks such as object detection, classification, and recognition. In the context of encoder-decoder neural networks, feature maps may incorporate temporal information. They capture and propagate features across multiple frames, allowing the machine learning model to understand the continuity and changes in the video sequence.

Examples of the types of features in a feature map can include low-level features (e.g., in early layers of the CNN) such as edges, lines, corners, basic textures; and high-level features (e.g., in deeper levels of the CNN) representing more complex and abstract features, including shapes, textures, object parts, whole objects, and/or the like. As the input video frame passes through multiple layers of the CNN, feature maps evolve from representing low-level features to more complex, high-level features. Various filters can be applied to the input video frame to produce various feature maps, each highlighting distinct patterns or features in the data.

The feature map serving as an input to a convolutional layer can be either the initial input image, or an output from a previous layer in the network. A feature map typically comprises multi-dimensional tensors with dimensions including height, width, and depth (e.g., number of channels).

A channel in a feature map represents a specific dimension of the input data that captures distinct characteristics or attributes of the information being processed. For example, the channels may correspond to color components for a color image. As another example, the channels may represent temporal information or other feature maps within the frames. For raw video input, channels may usually correspond to the red, green, and blue (RGB) color channels.

In the context of neural networks, input video frames are often represented by feature maps in the form of multi-dimensional arrays or tensors. A sequence of frames represents a series of consecutive frames, which carries temporal information of the video data. A frame is a single image within the video sequence captured at a specific point in time. The frames are typically processed in order, allowing the neural network to analyze both spatial and temporal information. Each frame typically has spatial dimensions (height and width) and channels.

A tensor is a multidimensional array of numerical data that serves as the data structure for representing and processing input data. Tensors generalize the concepts of scalars, vectors (one-dimensional array of numerical values that can encode various types of data, including inputs, outputs, and internal representations within the network), and matrices to higher dimensions.

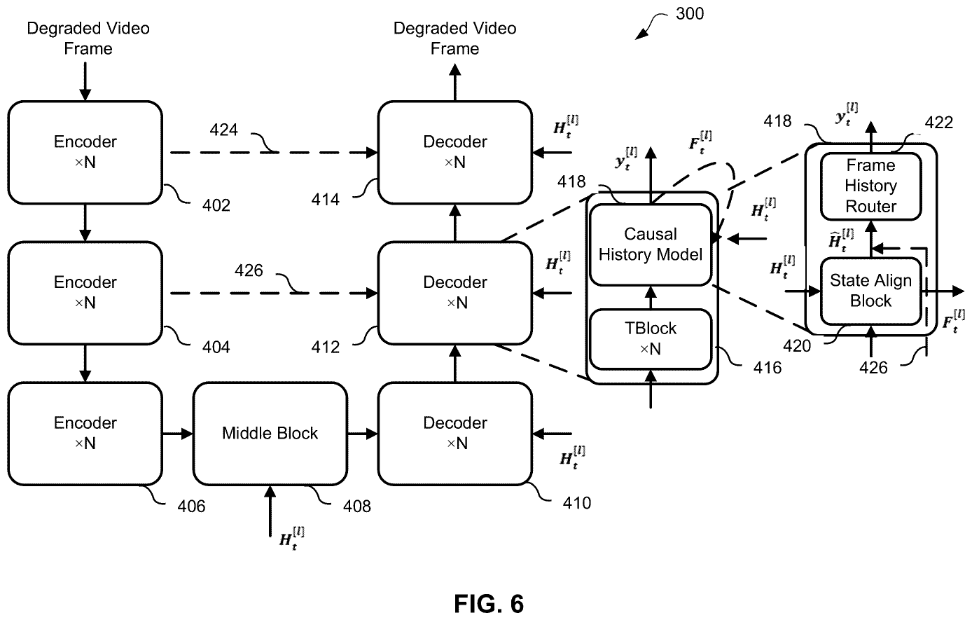

FIG. 6 is a schematic diagram of a structure of the video processing system 300, according to some embodiments of this disclosure.

Referring to FIG. 6, the video processing system 300 comprises an encoder-decoder architecture, including a plurality of encoders 402, 404, 406 and decoders 410, 412, 414. In some embodiments, the video processing system 300 may be based on a UNet architecture, which is a U-shaped neural network that has multiple encoder stages and decoder stages arranged in symmetry.

At each encoder stage, the encoder 402, 404, 406 processes the input frame, and produces a feature map (e.g., vector representation) of the input frame. The decoder 410, 412, 414 takes the encoded representation as input and generates the output frame.

The encoders 402, 404, 406, also referred to as the contracting path, are responsible for downsampling and extracting relevant features from the input frame. Each encoder 402, 404, 406 can include multiple convolutional layers for convolutional operations to extract spatial features from the input image, as will be explained in more detail. The multiple stages 402, 404, 406 progressively reduce the spatial dimensions (also reducing resolutions) of the input frame while increasing the number of feature channels. At each encoder or encoder stage 402, 404, 406, the input image or video frame gets downsampled by reducing spatial dimensions.

The decoders 410, 412, 414, also referred to as the expansive path, are responsible for upsampling and generating the final feature map for the output frame. The decoder 410, 412, 414 progressively increases the spatial dimensions (also increasing resolutions) of the feature maps and recovers spatial information. The decoders 410, 412, 414 gradually increase the spatial dimensions while decreases the number of feature channels in the feature map until the original resolution is recovered. The decoder applies convolutional operations to refine the upsampled features.

By way of an example, for an input frame of 256×256 (in pixels) of height and width, the first encoder stage 402 can decrease the spatial dimensions of the input image by reducing the height and width of the feature map by half to 128×128 of height and width. Similarly, the second encoder stage 404 decreases further the spatial dimensions of the input image by reducing the height and width of the feature map by half to 64×64 of height and width; and the third encoder stage 406 decreases further the spatial dimensions of the input image by reducing the height and width of the feature map by half to 32×32 of height and width. By decreasing the spatial dimensions of the input image, the number of computations required in subsequent layers is reduced. The last encoder stage 406 is the last down-sampling stage.

Conversely, the decoder stage 410 at the same level as the last encoder stage 406 starts to increase the spatial dimensions of the input image, by doubling the height and width of the feature map to 64×64 (in pixels) of height and width. The second decoder stage 412 then increases further the spatial dimensions of the input image by doubling the height and width of the feature map to 128×128 of height and width; and the last decoder stage 414 recovers the original spatial dimensions of the input image to 256×256 of height and width.

As will be readily appreciated by a skilled person, the number of stages of the encoder/decoder is determined by for example, the original size of the input video frame, and/or how small the down-sampling is designed to achieve. The number of stages of the encoder/decoder is not limited to three as shown in FIG. 6.

Optionally, the video processing system 300 may comprise a middle block 408 connecting the encoder 402, 404, 406 and decoder 410, 412, 414. The middle block 408 serves as a bridge between the encoders 402, 404, 406 and the decoders 410, 412, 414 and performs functions similar to a decoder 410, 412, 414, but without changing any spatial dimensions (or the resolution).

Referring to FIG. 6, the decoder 410, 412, 414 and the middle block 408 uses a history

$${H}_{t}^{[ l ]}$$

of an input frame for processing of the input frame at time stamp t. As will be explained in more detail, the history

$${H}_{t}^{[ l ]}$$

of the input frame comprises a sequence of frames of the video preceding the input frame of up to a first predetermined number. l represents the dimensions of the representation space (i.e., feature maps).

The model may further comprise skip connections 424, 426 between the same level or stage of the encoder and decoder, which can be used to transfer feature maps from the encoder 402, 404 to the corresponding level or stage of the decoder 414, 412, respectively. This can help preserve, in the decoding process, fine-grained spatial information that may have been lost during the encoding process. The skip connections can also enable precise localization of segmentation boundaries.

In some embodiments, each encoder or decoder stage may stack N multiple encoders or decoders, arranged sequentially. Each block of the encoder or decoder may perform a corresponding transformation on the data as it flows through the network, providing better and more nuanced representations of the input image or frame.

### Historyless Encoder

Referring to FIG. 6, the encoders 402, 404, 406 included in the system 300 processes only a single input frame at a time and do not consider any history.

In the context of neural networks, the terms “historyless” or “memoryless” refer to a module or component that does not rely on past information when processing current inputs. In other words, the encoder 402, 404, 406 processes each input frame independently, without considering previous input frames or states.

In some embodiments, the encoder 402, 404, 406 each comprises at least one FFN, without any computationally expensive operations, such as an attention module used in a transformer (TBlock). The encoder 402, 404, 406 does not have recurrent connections or feedback loops where outputs from a layer are fed back into the same or previous layers. Each computation is performed based solely on the current input frame, without relying on any hidden state that changes over time.

FFN is a type of artificial neural network that only includes plain layers (either linear or otherwise) that generates an output by applying a learnable operation to an input. In an FFN, data flows only in one direction, from input to output, without any loops or cycles.

In some embodiments, several (e.g., N) convolutional feedforward blocks can be stacked at each of the encoder stages 402, 404, 406 for downsampling the spatial resolution and inflating the channels by a factor of 2.

Since the encoder 402, 404, 406 only considers a single frame at a time, it is lightweight in the number of parameters and Giga floating point operations per second (FLOPs) (G). This is based on an observation that at the encoder stage, the network has not learned to restore (or recover details) of the frame, and therefore expensive operations such as attention, or considering the history would provide little benefit, other than increasing in parameters and FLOPs. FLOPs are an important metric used to measure the computational complexity and performance of machine learning models.

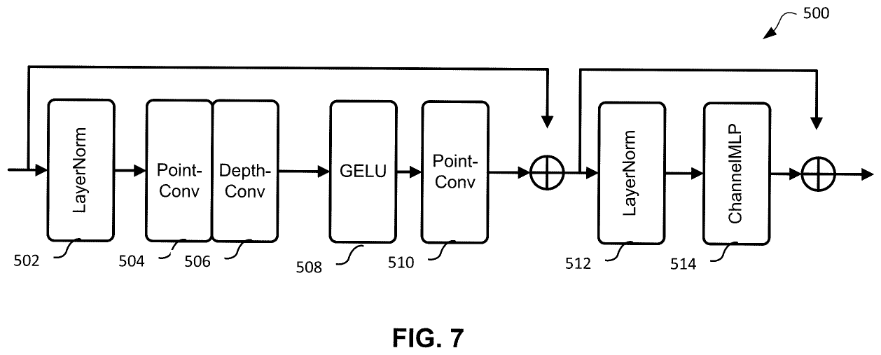

FIG. 7 is a schematic diagram of the structure of an exemplary encoder 500, according to some embodiments of this disclosure. For example, the exemplary encoder 500 may represent each of the N block of the encoder 402, 404, 406 illustrated in FIG. 6.

At timestep t, the single input frame is passed to encoder 402, 404, 406. The input frame gets passed through one or more convolutional layers at each encoder stage, which projects features and inflates the channels in the representation space (i.e., the feature map) to extract more features for the following downsampling stages. The output of the encoder stages 402, 404, 406 is a feature map

$${F}_{t}^{[ l ]}$$

representing the input frame at time stamp t.

In this exemplary embodiment, the encoder 500 can comprise a normalization layer (LayerNorm) 502 to normalize the input for each encoder stage, helping to stabilize and accelerate the training process. For example, LayerNorm 502 can normalize the activations across features for each input frame independently. The LayerNorm 502 can compute the mean and variance across the features for each input frame in an encoder stage. It then normalizes the input frame by subtracting the mean and dividing by the standard deviation. The LayerNorm 502 applies learnable scale and shift parameters to the normalized values.

The encoder 500 can further comprise a pointwise convolution 504 (abbreviated as “point-conv”) and at least one depthwise convolution (abbreviated as “depth-conv”) 506.

The pointwise convolution 504, known as lxi convolution, is a type of convolutional layer that uses a lxi kernel for changing the number of channels in the output and creating a linear combination of input channels. In other words, the kernel iterates through every single point in the input. As shown in FIG. 7, the pointwise convolution 504 is used in conjunction with at least one depthwise convolution 506 to form depthwise separable convolutions. The depthwise convolution 506 applies separate filters to each input channel, maintaining the same number of channels as the input. In an example, the depthwise convolution 506 may be a 3×3 convolution that uses 3×3 kernel to extract features from the input image or feature map.

The encoder 500 can further comprise a gaussian error linear unit (GELU) 508, which applies a non-linear transformation to the input, providing a smooth transition across the entire input range. The GELU 508 can be followed by another pointwise convolution 510.

The results can then be added to the input (e.g., via a skip connection 424, 426) by an elementwise addition (vector addition or array addition) before fed into another normalization layer 512. A channel multi-layer perceptron (MLP) 514 is included which serves to combine information across features or channels. The results of the channel MLP 514 are again added to the output of the pointwise convolution 510, by an elementwise addition before producing the output.

As can be appreciated from the described embodiments, the encoder 402, 404, 406 does not include any attention module and is historyless by design. This pertains to the observation that earlier feature extraction stages, such as the encoder stages, do not fully remove the degradations from the input. Therefore, expensive operations such as the attention mechanisms do not offset the additional computational cost. As such, plain convolutional feedforward blocks are used in place of an attention operator according to various embodiments.

The structure of the encoder 500 is not limited to the exemplary example shown in FIG. 7, but is flexible depending on the specific designs of the blocks. For example, other non-linear activation blocks may be used in place of the GELU 518, such as a rectified linear unit (ReLU), a block based on the Sigmoid function, and the like.

However, by not resorting to an attention operator early in the process and not conditioning the encoder on the history of the frames, the video processing methods, systems, and computer-readable medium as described in the embodiments show significant savings in computational and memory costs. As described, this is based on an understanding that the features are not reliably free from degradation information at this stage, and therefore only conditioning on the history of the frames at the decoder stage is sufficient and can save memory space.

### Causal History Model

Referring to FIG. 6, each decoder 410, 412, 414 comprises a causal history model 418 and a transformer, or TBlock 416.

According to some embodiments of this disclosure, the TBlock 416 is a neural network built on an attention operator or attention mechanism followed by an MLP. The TBlock 416 allows the machine learning model to weigh in the importance of different parts of the input frame. It takes a single input frame as input without referring to the history of the input frame. For example, given an input frame, the TBlock 416 provides the relationship or similarity for every batch or region in the frame in relation to the other regions of the frame.

Attention operator is a specialized operator that attends to each region in the input frame. If it attends to itself spatially, it is known as spatial attention; if it attends to the channels, it is known as channel attention. The attention mechanism can be self-attention when referring to the same input vector; or cross-attention when referring across different vectors.

According to various embodiments of this disclosure, the video processing methods and systems are powered by a functional block 418, referred to as the causal history model (CHM). The CHM 418 maps an input sequence of frame features to an output sequence through an implicit latent stage, as will be explained in more detail.

In videos, motion governs the entire trajectory, and therefore any linear combination of previous frames with the current frame is intractable unless the motion is compensated for. In video restoration, this is even more complicated since motion compensation is unreliable when the pixel intensities change across the trajectory. According to various embodiments of this disclosure, the CHM 418 transforms the input to the output through a motion compensated history state, and therefore allows for information borrowing across the trajectory.

According to various embodiments of this disclosure, the CHM maintains a truncated history

$${H}_{t}^{[ l ]}$$

of the input frame up to a first predetermined number of frames. In some embodiments, the first predetermined number T is 3. Further, because the CHM 418 in the inference stage is stateful by continuously processing each frame of the video for restoration without resetting a state of the decoder, the CHM 418 can learn implicitly from a history of the input frame for the entire trajectory. Referring to FIG. 6, the output Fₜ^{[l]} of the CHM at time stamp t is fed back to the model as the history of the input frame for the next time stamp.

According to various embodiments of this disclosure, the CHM 418 learns to align the history states with respect to the input feature map. Further, there could still exist potential degradation differences at the same feature locations along the entire sequence in the motion-compensated history states since motion affects each pixel and is non-uniform throughout the trajectory. To this end, the CHM 418 is configured to re-weigh the sequence along the temporal dimension to accentuate significant features and suppress irrelevant ones.

Referring to FIG. 6, the CHM 418 comprises two components: a state align block (SAB) 420 and a frame history router (FHR) 422, also referred to as a soft router.

According to various embodiments, for each first region of the input frame, the SAB 420 can search for at least one second region most relevant to the corresponding first region in the history of the input frame; and generate the motion compensated history of the input frame based on a correspondence between each first region and the corresponding at least one second region.

In particular, the SAB 420 is configured to consider the historical

$${H}_{t}^{[ l ]}$$

of the input frame, as well as the input frame

$${F}_{t}^{[ l ]}$$

under restoration, to generate the motion compensated history of the input frame. In particular, for each region in the input frame, the SAB 420 can learn most relevant regions of interest in the entire history. In some embodiments of this disclosure, the attention operators in the middle or decoder stages are limited to top-K relevant regions in the history. That is, for every region of the input frame, the SAB 420 can select top-k most relevant regions in the history, thereby allowing only the most important and principal information to aid in the restoration of that particular region. In some embodiments, k=5.

Referring to FIG. 6, the output

$${F}_{t}^{[ l ]}$$

of the SAB at time stamp t is fed back to the model as the history of the input frame for the next time stamp.

According to various embodiments, the FHR 422 can assign weights to the motion compensated sequence of frames, based on an importance of a corresponding frame to the input frame for each region of the input frame. A weighted sum of the motion compensated sequence of frames is calculated for generating the output frame.

Since pixel displacement is usually across few frames and not all frames are equally important, the FHR 422 is configured to learn to aggregate information from the entire trajectory, and re-weigh the important regions. Once the history is motion compensated after the SAB 420, the video processing method arrives at the latent state where information from the history can be combined with the input. The FHR 422 then utilizes this latent state and returns the output sequence that is restored. Referring to FIG. 6, feature maps

$${F}_{t}^{[ l ]}$$

may be transmitted to the CHM 418 through the skip connections 426, for use in the FHR 422.

In principle, CHM is a sequence-to-sequence mapping between the input sequence and the output sequence, through a motion compensated history of previous states. Here, the input sequence comprises the history of the input frame of up to the first predetermined number concatenated with the input frame; and the output sequence represents the motion compensated and restored input sequence.

The relationship between the input and the output can be represented as the following equations (1) and (2):

$$MotionCompensatedHistory = concat ( SAB ( History , Input ) , Input ) \qquad ( 1 )$$

$$Output = FHR ( MotionCompensatedHistory , Input ) + Input \qquad ( 2 )$$

where SAB refers to the SAB 420 operation that implicitly compensates for motion, while FHR refers to the FHR 422 operation that re-weighs the sequence that can then be linearly combined with the input.

In the equations (1) and (2), “history” refers to a history of the input frame of up to the first predetermined number; “input” refers to the input frame or input feature map; “concat” represents the concatenating operator; and the output refers to the output frame. The concatenation operation can be used to combine feature maps or tensors along a specified dimension, typically along the channel or depth dimension.

For example, assume the input frame is represented by m channels; and the output of SAB operations produce n channels. The motion compensated history corresponds to a combination of m+n channels concatenated along the channel or depth dimension.

As can be seen in equation (1), the motion compensated history of an input frame can be generated based on the input frame and the history of the input frame.

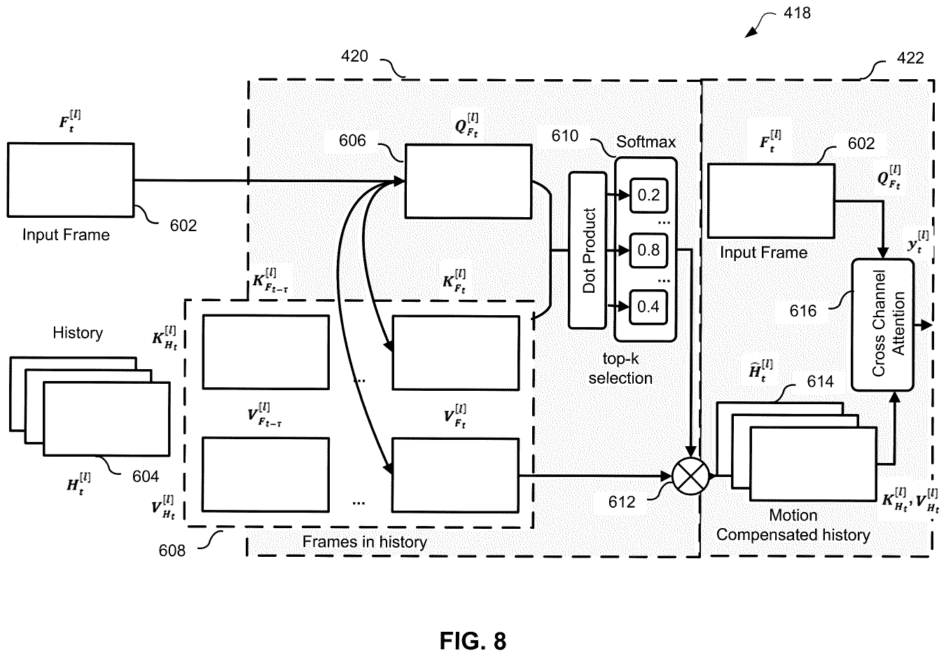

FIG. 8 is a schematic diagram of the structure of the CHM 418, according to some embodiments of this disclosure.

Referring to FIG. 8, the input frame is represented by feature map

$${F}_{t}^{[ l ]}$$

602. The history of the input frame of up to the predetermined number is denoted as

$${H}_{t}^{[ l ]}$$

604. t represents temporal information, and l represents the dimensions of the representation space (i.e., the feature map)

$${H}_{t}^{[ l ]} = \{ {F}_{t - 1}^{[ l ]} , {F}_{t - 2}^{[ l ]} , … , {F}_{t - τ}^{[ l ]} \} ,$$

τ corresponds to the first predetermined number of frames in the history. In some embodiments, i=3.

In some embodiments of this disclosure, the history

$${H}_{t}^{[ l ]}$$

604 of the input frame is realized through caching the key and value vectors in the attention mechanism.

In an attention mechanism, the input can be projected to three vectors called query (Q), key (K), value (V). The attention mechanism operates by re-weighing the value vector (V) by computing the similarity score between the query (Q) and key (K). If the query (Q) and the key (K) originate from a same input vector, then the attention is referred to as self-attention. On the other hand, if query (Q) and the key (K) originate from different vectors, then the attention is referred to as cross-attention.

The feature map

$${F}_{t}^{[ l ]}$$

representing the input frame can be projected to query (Q)

$${Q}_{{F}_{t}}^{[ l ]}$$

606, through e.g., one or more convolutional layers so that each of the pixel of

$${F}_{t}^{[ l ]}$$

can have weights assigned to it. Accordingly, the current input frame

$${F}_{t}^{[ l ]}$$

602 is projected to compute the query (Q)

$${Q}_{{F}_{t}}^{[ l ]}$$

606, which can be used to extract the key

$${K}_{{F}_{t}}^{[ l ]}$$

and the value

$${V}_{{F}_{t}}^{[ l ]}$$

of the input frame.

The CHM 418 utilizes a variant of cross-attention where key (K)

$${K}_{{H}_{t}}^{[ l ]}$$

and value (V)

$${V}_{{H}_{t}}^{[ l ]}$$

are taken from the history

$${H}_{t}^{[ l ]}$$

604 of the input frame. For example,

$${K}_{{H}_{t}}^{[ l ]} = \{ {K}_{{F}_{t - 1}}^{[ l ]} , {K}_{{F}_{t - 2}}^{[ l ]} , … , {K}_{{F}_{t - τ}}^{[ l ]} \} ; and {V}_{{H}_{t}}^{[ l ]} = \{ {V}_{{F}_{t - 1}}^{[ l ]} , {V}_{{F}_{t - 2}}^{[ l ]} , … , {V}_{{F}_{t - τ}}^{[ l ]} \} .$$

Here, the history H can be defined as a set of K and V vectors, i.e., H={K, V}.

The methods and systems as described herein allow for spatially attending to regions along the entire history. Intuitively, it learns which regions in the history are most important for the current value vector of the input frame, given the similarity between the input query vector (Q), and key vector (K) from the history.

Since the similarity is computed over all the regions, it can be computationally expensive. The CHM 418 is configured to search for the least one region most relevant to each region in the input frame based on a top-k search of a maximum of k regions in the history. In other words, CHM narrows the attention in the history to top-k regions i.e., only looks at maximum of k regions in the history. This can construct a sparse attention map where non-relevant regions with respect to each input region are set to zero. Once the information has been aggregated, the history can be thought of as compensated for motion with respect to the input frame i.e., a one-to-top-k temporal correspondence between a region of the input frame and top-k regions in the history is learned for the entire input sequence.

Referring to FIG. 8, the SAB 420 uses a softmax operation 610 for performing the top-k selection of most relevant regions. In particular, the softmax operation 610 converts the input values from

$${Q}_{{F}_{t}}^{[ l ]}$$

606 and

$$\{ {K}_{{H}_{t}}^{[ l ]} , {V}_{{H}_{t}}^{[ l ]} \}$$

608 into a probability distribution, outputting a corresponding probability in the range of (0, 1). The probabilities are then used to calculate the weighted sum of inputs, by a dot product.

For example, for every batch or region in

$${Q}_{{F}_{t}}^{[ l ]}$$

606, the top k most relevant or similar regions in the history are located. For the top-k selection, softmax values are computed, e.g., 0.8 for the most relevant region, 0.4 for the next relevant region, and 0.2 for the third relevant region. The output of the softmax operation 610 is multiplied with the

$${V}_{{F}_{t}}^{[ l ]}$$

via the matrix multiplication 612.

The generated motion compensated sequence of frames is concatenated (not shown) with the input frame as shown in equation (1) to generate a motion compensated history 614

$${\hat{H}}_{t}^{[ l ]}$$

of the input frame, which serves as the input to FHR 422.

The CHM 418 is also configured to route information from the history in a specific manner. Once the history is motion compensated after the SAB 420, the FHR 422 is configured to learn to route the information. This is because not all regions at various temporal scales are equally important for the current input frame. Since degradation does not affect the input uniformly, it might be the case that for region p1 in the input at timestep t, region p1 in the history at timestep t−2 is more relevant than the same region at timestep t−1. Therefore, the FHR 422 learns a routing mask to allow for information flow and compute the output vector.

In other words, for each input frame, the most important channels are learned, and as a result the most important channels are highlighted and the others are suppressed. When concatenating the history with the input frame as shown in equation (2), the resultant sequence includes temporal information embedded therein, as it includes frames along these channel dimensions.

Herein, a routing mask refers to a technique used to selectively control the flow of information through the network. It allows for dynamic routing of data and gradients during training and inference, enabling more flexible and efficient computation.

Referring to FIG. 8, the FHR 418 is implemented through a cross-channel attention (or cross-frame attention) 616 where each channel in the motion compensated history 614 represents temporal information. Therefore, the attention 616 acts as a soft router assigning necessary weights to the channel that holds the most value for the current input frame, while the less important channels are less emphasized on.

The output

$${y}_{t}^{[ l ]}$$

can be generated, based on the results of the cross-channel attention 616. In some embodiments, the output is added to the input frame (e.g., through the skip connection 426) without losing finer details of the input frame, before producing the final output frame, as shown in equation (2).

According to various embodiments of this disclosure, the CHM 418 operates in either a stateful or stateless configuration, depending on the stage of the machine learning model.

Herein, the term “stateless” refers to resetting internal states to zero at the beginning of each new input sequence or batch. Accordingly, each input sequence is treated independently, without maintaining memory of past sequences across different batches. In contrast, a “stateful” network maintains the internal states between batches or sequences of input data, allowing the network to carry forward information from previous inputs over a longer period.

During training or a training stage, the CHM 418 benefits from recurrence only among clips of a second predetermined number of frames, and hence is stateless in training. According to some embodiments, the number of video frames in a clip may be limited to 5.

In contrast, in inference stage or during deployment, the CHM 418 is stateful and maintains the entire trajectory implicitly. Further, the CHM 418 does not involve any autoregressive model which directly uses past inputs as additional features and predicts future values based on past values in a sequence, but instead relies on hidden states. Therefore, unlike many contemporary recurrent methods which are autoregressive, the embodiments described do not involve compounding error of estimation.

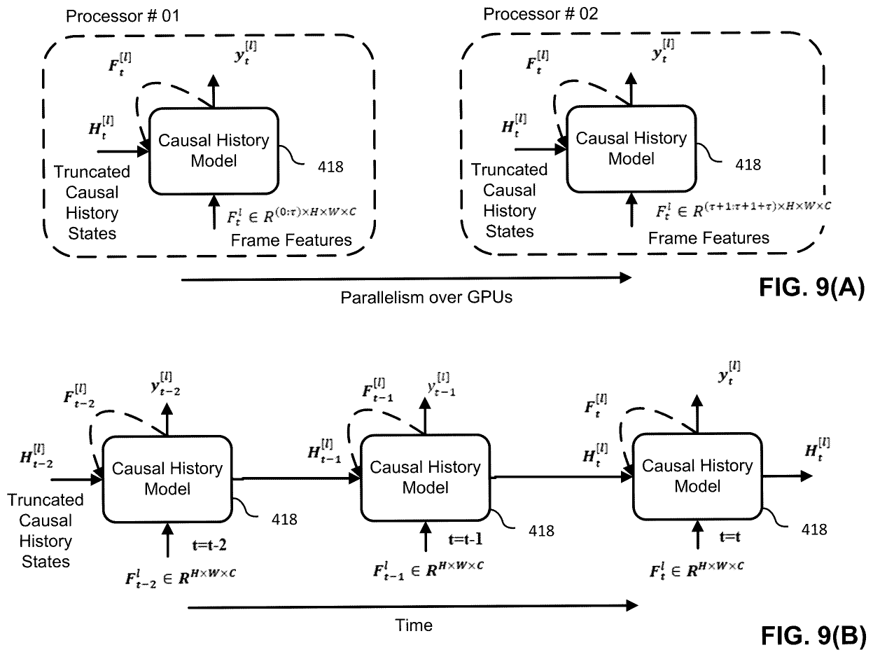

FIG. 9(A) and FIG. 9(B) show the two different views or modes of the CHM 418, according to some embodiments of this disclosure. In particular, FIG. 9(A) provides the training, or stateless view of the CHM 418, where after the second predetermined number of frames, the state resets; FIG. 9(B) provides the inference, or stateful view of the CHM 418, where explicitly T frames are maintained and implicitly the entire trajectory can be learned in the history.

Referring to FIG. 9(A), the video can be segregated into separate clips of frames. Different clips can be trained parallelly, utilizing separate processors in training. For example, a first clip of frames with time stamps of 0, 1, 2, . . . T (i.e., a total of T+1 of frames) can be trained in the CHM 418 using a first processor (for example, a first GPU). A second clip of frames with time stamps T+1, . . . T+1+T can be parallelly trained in a separate processor (for example, a second GPU). The frame features can be represented by a four-dimensional tensor

$${F}_{t}^{l} ∈ {R}^{( 0 : τ ) \times H \times W \times C}$$

for the first clip of frames, a four-dimensional tensor

$${F}_{t}^{l} ∈ {R}^{( τ + 1 : τ + 1 + τ ) \times H \times W \times C}$$

for the second clip of frames, where t is the time stamp, T is the number of frames explicitly maintained in the history of the input frame, H is the height of the input frame, W is the width of the input frame, and C is the channels of the input frame. For example, C can represent the colors of the input frame.

Now referring to FIG. 9(B), in inference during deployment, each frame of the video for restoration is continuously processed without resetting a state of the decoder or the CHM 418. At time stamp t=t−2, the input frame with a time stamp t−2, represented by the feature map

$${F}_{t - 2}^{l} ∈ {R}^{H \times W \times C} ,$$

is input into the CHM 418. The input feature map combined with the history

$${H}_{t - 2}^{[ l ]}$$

of the input frame of up to the first predetermined number of frames are used to generate the output frame

$${y}_{t - 2}^{[ l ]} .$$

Similarly, time stamp t=t−1, the input frame with a time stamp t−1, represented by the feature map

$${F}_{t - 1}^{l} ∈ {R}^{H \times W \times C} ,$$

is input into the CHM 418. The input feature map combined with the history

$${H}_{t - 1}^{[ l ]}$$

of the input frame of up to the first predetermined number of frames are used to generate the output frame

$${y}_{t - 1}^{[ l ]} .$$

At time stamp t=t, the input frame with a time stamp t, represented by the feature map

$${F}_{t}^{l} ∈ {R}^{H \times W \times C} ,$$

is input into the CHM 418. The input feature map combined with the history

$${H}_{t}^{[ l ]}$$

of the input frame of up to the first predetermined number of frames are used to generate the output frame

$${y}_{t}^{[ l ]} .$$

As can be seen from FIG. 9(B), the history state

$${H}_{t}^{[ l ]}$$

is not reset after each clip, but carries through the entire video, thereby implicitly maintaining the state of the entire history of the video.

In training, the CHM 418 is stateless so that the processes and systems can be efficient. The training video can be divided into clips and the recurrent structure of CHM 418 is only maintained within the clip. This allows for parallelism over the training data since the memory buffers (implemented through a running queue) are reset when the clip ends. In one exemplary example, a video clip of a second predetermined number (e.g., 5) frames can be sampled from the training dataset, and as a single frame is processed, the history is limited to T previous frames in a sliding window fashion. Once a certain clip ends, a new video clip of the second predetermined number frames can be sampled from the dataset. Accordingly, data parallelism allows the system to train quickly.

Further, it is considered that little information of significant importance in degradations exists beyond the neighborhood of a limited number of frames (such as 5 frames). Degradations like rain, haze, snow, etc. affect the videos rapidly. In other words, the change in pixel values and the local regions in the frame do not remain consistent. Similarly, object motion can aggressively change the scene, e.g., considering how a moving car can move out of the video in a couple of frames. Therefore, for practical reasons, only considering the frame neighborhood of a limited number of frames, such as 5 frames, with 3 frames being explicitly maintained, can be valid and implemented.

Turtle behaves differently in inference, as compared to training. This is because inference benefits from the longer range of the stream of frames. While a first truncated number T of frames are still explicitly maintained, the state is not reset after each clip. Rather, the sliding window rolls over, and only ends when the video is finished. The stateful configuration of the CHM 418 is consistent with the resource constraints in the inference stage. The video processing methods and systems according to various embodiments do not assume the availability of a multi-GPU farm, unlike many conventional contemporary methods. Therefore, during deployment in the inference stage, the described video processing methods and systems can run on a single consumer-grade GPU. For example, the video processing methods and systems according to various embodiments can handle videos up to 1080p and a patch of size 256×256×3 and process a frame around 95 ms.

In literature, the potential of caches (or history) has not been explored for video restoration since computing has been utilized to process multitude of frames on-the-go. However, the video processing methods and systems according to various embodiments can trade off a slight increase in memory for extensive savings in computation, while maintaining competitive performance and restoring the results with high perceptual quality.

The video systems, methods, apparatuses, and computer readable medium described herein therefore provide a solution that can offer efficiency in training, and the ability to deploy on a consumer-grade GPU without the need for multi-GPUs. While in training, the multi-GPU setup can be exploited to accelerate the training procedure.

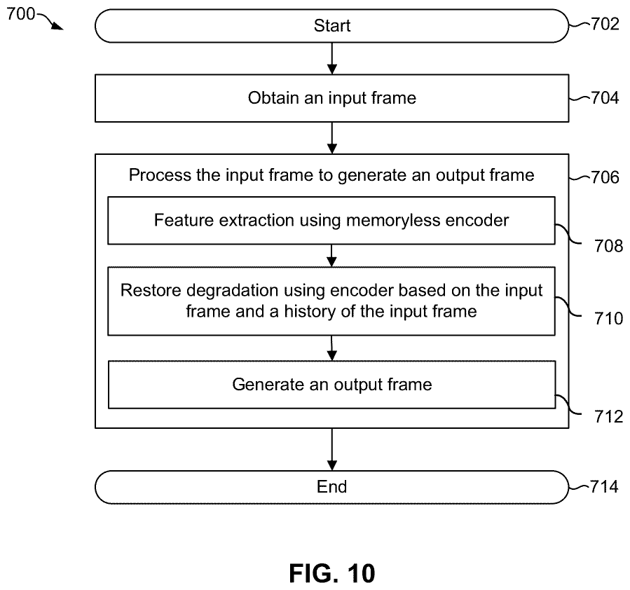

FIG. 10 is a flowchart showing operations of a method (700) of a video processing method, according to some embodiments of this disclosure.

The method (700) starts at operation (702). The method (700) comprises obtaining (704) an input frame from a video for restoration; and processing (706) the input frame to generate an output frame using a neural-network-based machine learning model. As described above, the machine learning model (referred to as “Turtle”) is based on an encoder-decoder architecture comprising at least one memoryless encoder and at least one decoder.

According to various embodiments of this disclosure, processing the input frame to generate the output frame comprises processing (708) the input frame using the at least one memoryless encoder to extract features from the input frame; and restoring (710) at least one degradation contained in the input frame using the at least one decoder, based on the input frame and a history of the input frame. The history of the input frame comprises a sequence of frames of the video preceding the input frame of up to a first predetermined number. The output frame is then generated (712) with restored degradation. The method ends at operation (714).

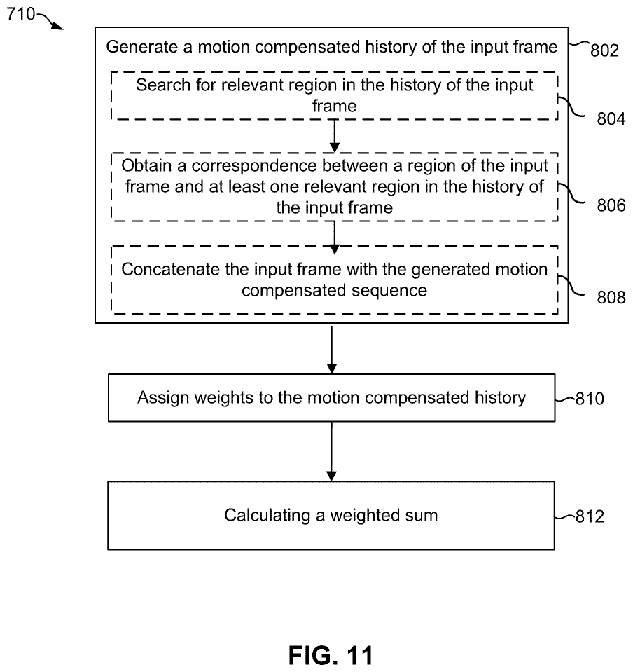

FIG. 11 is a flowchart showing operations of restoring (710) at least one degradation contained in the input frame, according to some embodiments of this disclosure.

For restoring at least one degradation contained in the input frame, a motion compensated history of the input frame can be generated (802) based on the input frame and a history of the input frame.

According to some embodiments, the input frame comprises a plurality of first regions, and generating the motion compensated history of the input frame can comprise: for each first region of the input frame, searching (804) for at least one second region most relevant to the corresponding first region in the history of the input frame; and obtaining (806) a correspondence between each first region and the corresponding at least one second region in the history of the input frame. Generating the motion compensated history of the input frame may further comprise concatenating (808) the input frame with a motion compensated sequence of frames generated from operations (806).

The method (710) can further comprise assigning (810) weights to the motion compensated history of the input frame, based on an importance of a corresponding frame in the motion compensated history of the input frame to the input frame. A weighted sum of the motion compensated sequence of frames can be calculated (812) for generating the output frame.

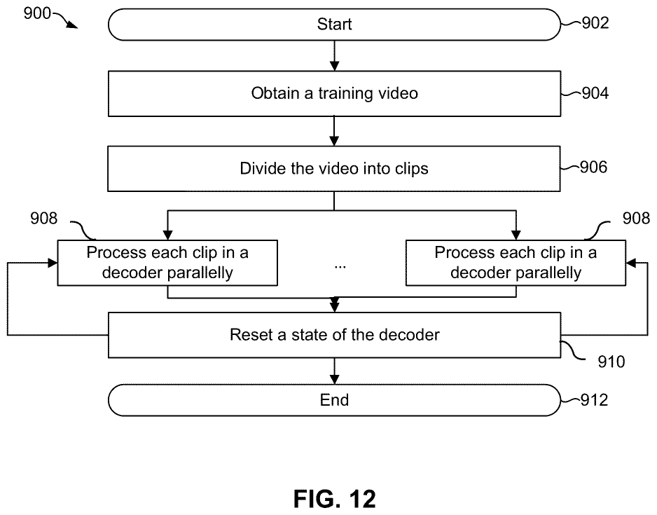

FIG. 12 is a flowchart of a method (900) showing operations of training the machine learning model, according to some embodiments of this disclosure.

The method starts at operation (902) and comprises obtaining (904) at least one training video. The training video may be obtained from representative training datasets for a specific usage or application, such as representing rain induced degradations, snow induced degradations or the like. The representative training datasets may be chosen depending on the specific usage or application of the machine training model 148′. Each training video is then divided (906) into a plurality of clips, each clip comprising a second predetermined number (e.g. 5) of training frames. During the training stage, two or more clips can be processed (908) using two or more decoders in parallel. After the training of each clip is completed, a state of each decoder can be reset (910). The process of training the clips parallelly can be repeated until the training of the entirety of the at least one training video is completed. The method ends at operation (912).

There are several characteristics of the various embodiments described herein.

### Efficient Video Processing

The described methods and systems can benefit from the advantages of both recurrent and parallel methods. The methods and systems described are stateless during training, in that the states are reset at the end of the sequence of the frames. In other words, training of the clips of frames is parallel and the processing of a next clip does not depend on the previous history. Non-autoregressive recurrence is limited to only a predetermined number of frames, e.g., T number of frames. In contrast, during inference the methods and systems described resort to the recurrent view and processes the video recurrently while keeping track of the entire history of the frame under restoration. Since explicitly only a truncated number of frames are maintained, the memory cost can be reduced even in inference. However, all the frames from timestep 0 to timestep t may be implicitly considered in the machine learning model for restoring a frame at a time stamp t, to benefit from the entire previous trajectory. In other words, the methods and systems described resort to a stateful processing because it implicitly maintains the entire state as each frame rolls in.

### Efficient Motion Compensation

The methods described do not rely on explicit motion compensation methods such as optical flow, and therefore, represent a stand-alone video restoration and/or video processing method. Accordingly, there is no additional computational overhead, and the methods described can restore a video end-to-end. The methods and systems described implicitly learn to compensate for the motion via selecting most relevant regions of information in the frames across the history of the input frame.

### Computational Tractability:

The methods and systems described are hardware friendly since it processes only a single frame at a time (as the input to the encoder), while conditioning the restoration of the frame on the history of the input frame. The history explicitly maintained is truncated for up to τ (e.g., 3) frames, while in inference it can build the entire implicit view of history as the frames roll in and as the video is restored. Further, the encoder is lightweight and does not incorporate expensive attention operators. As such, the methods and systems described can scale to various video resolutions from 256×256×3, all the way to 1080p (1920×1080×3) on a single consumer grade GPU and can process the frame in 95 ms per frame.

### Online Video Processing:

Further, the methods and systems described do not consider any frame in the future, which is causal by design, and only store a truncated number of frames in the history at a time, which make them suitable for online video processing. To restore any frame, it only considers the history of the input frame and does not wait for any future frame(s) to arrive. Unlike conventional contemporary video restoration methods which store frames in both history and future to process a single frame, the described methods and systems can be particularly efficient and can reduce computational overhead.

### Generalizability

The methods and systems described embodies a general video processing framework that can be applied to a variety of video restoration applications, including video processing applications online. Most traditional general video restoration methods are not online and can also be computationally intensive.

The video systems, methods, apparatuses, and computer readable medium described herein employ a standalone neural network that can run on end-user devices to clean up videos and remove various degradations. The described systems, methods, apparatuses, and computer readable medium described herein can process videos up to 1080p (1920×1080×3) on consumer-grade GPUs while remaining efficient and computationally tractable. Further, a single frame can be processed in 95 ms according to the embodiments described. In comparison, conventional generic restoration methods cannot process videos beyond 256×256×3 resolution on a single GPU and may take well over 200 ms on a single consumer grade GPU to process a frame.

The described video processing methods have been experimented on a plurality of restoration tasks including video de-snowing, night video de-raining, real-world video deblurring, synthetic video deblurring, video raindrop and rain streak removal, video super resolution, and blind video de-noising. The results have shown that the described video processing or restoration methods can provide high-perceptual quality results, outperforming conventional methods in terms of peak signal-to-noise ratio (PSNR) and structural similarity index measure (SSIM).

Therefore, the described video systems, methods, apparatuses, and computer readable medium can be suitable in various applications or edge devices, including but not limited to video streaming (for video platforms), consumer cameras (for camera and smartphone manufacturers), action cameras (for action camera manufacturers), autonomous vehicles (to process videos captured on the go for security, safety, and interpretable decision making), UAVs (for UAV manufacturers to capture high-quality footage), surveillance (for CCTV manufacturers), and even digital pathology where capturing high-quality videos are necessary to make a clinical decision accurately. Such efficient video processing or restoration methods can be particularly helpful in various use scenarios, such as underwater videos, or videos where natural weather degrades the captured videos or blurs, causing unwanted artifacts.

The described systems, methods, apparatuses, and computer readable medium provide an efficient, online solution of sequential data by leveraging historical context without relying on computationally intensive operations such as explicit motion compensation. The methods and systems can extend beyond video restoration, and contribute to other sequential decision-making tasks by efficiently processing sequential data and leveraging historical context.

For example, the methods and systems described can be used for audio signal processing to reduce noise with low delay and reduced resources, making it suitable for live audio applications and devices such as smartphones and wireless/wired headphones, and even hearing aids. It can also improve music streaming quality by correcting artifacts and adapting to network changes, enhancing user experience, and conserving device resources. Further, in video tasks, the methods and systems described efficiently use historical frames to improve performance. It could be used for video generation to create smooth frame transitions and support real-time animations. In video understanding, the methods and systems described could be used to enhance action recognition and real-time analysis, which is valuable for applications like surveillance and autonomous driving.

Although embodiments have been described above with reference to the accompanying drawings, those of skill in the art will appreciate that variations and modifications may be made without departing from the scope thereof as defined by the appended claims.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g., “such as”) is intended merely to better illustrate or describe embodiments of the invention and is not intended to limit the scope of the invention unless otherwise claimed.

1. A computerized video processing method, comprising:
obtaining an input frame from a video for restoration; and
processing the input frame to generate an output frame using a neural-network-based machine learning model, wherein the machine learning model is based on an encoder-decoder architecture comprising at least one memoryless encoder and at least one decoder;
wherein processing the input frame to generate the output frame comprises:
processing the input frame using the at least one memoryless encoder to extract features from the input frame;
restoring at least one degradation contained in the input frame using the at least one decoder, based on the input frame and a history of the input frame, the history of the input frame comprising a sequence of frames of the video preceding the input frame of up to a first predetermined number; and
generating the output frame with restored degradation.

2. The method according to claim 1, wherein restoring at least one degradation contained in the input frame comprises:
generating a motion compensated history of the input frame, based on the input frame and the history of the input frame.

3. The method according to claim 2, wherein the input frame comprises a plurality of first regions, and wherein generating the motion compensated history of the input frame comprises:
for each first region of the input frame, searching for at least one second region most relevant to the corresponding first region in the history of the input frame; and
generating the motion compensated history of the input frame based on a correspondence between each first region and the corresponding at least one second region.

4. The method according to claim 3, wherein searching for the at least one second region is based on a top-k search of a maximum of k regions in the history of the input frame for the at least one second region most relevant to each first region.

5. The method according to claim 2, wherein restoring at least one degradation contained in the input frame further comprises:
assigning weights to the motion compensated history of the input frame, based on an importance of a corresponding frame in the motion compensated history of the input frame to the input frame; and
calculating a weighted sum of the motion compensated history of the input frame for generating the output frame.

6. The method according to claim 1, wherein the machine learning model is based on a U-Net structure.

7. The method according to claim 1, wherein each of the at least one encoder comprises at least one feed forward network (FFN).

8. The method according to claim 1, wherein the first predetermined number is 3.

9. The method according to claim 1, wherein the machine learning model is trained though operations comprising:
obtaining a training video;
dividing the training video into a plurality of clips, each clip comprising a second predetermined number of training frames;
processing two or more clips using two or more decoders in parallel; and
resetting a state of each decoder once the processing of a corresponding clip is completed.

10. The method according to claim 1, further comprising continuously processing each frame of the video for restoration without resetting a state of the at least one decoder.

11. An apparatus for video processing, comprising
at least one processor; and
a non-transitory computer-readable storage medium coupled to the at least one processor and recorded thereon computer-readable instructions for execution by the at least one processor, wherein the instructions, when executed by the at least one processor, configures the apparatus to carry out a computerized method comprising:
obtaining an input frame from a video for restoration; and
processing the input frame to generate an output frame using a neural-network-based machine learning model, wherein the machine learning model is based on an encoder-decoder architecture comprising at least one memoryless encoder and at least one decoder;
wherein processing the input frame to generate the output frame comprises:
processing the input frame using the at least one memoryless encoder to extract features from the input frame;
restoring at least one degradation contained in the input frame using the at least one decoder, based on the input frame and a history of the input frame, the history of the input frame comprising a sequence of frames of the video preceding the input frame of up to a first predetermined number; and
generating the output frame with restored degradation.

12. The apparatus according to claim 11, wherein restoring at least one degradation contained in the input frame comprises:
generating a motion compensated history of the input frame, based on the input frame and the history of the input frame.

13. The apparatus according to claim 12, wherein the input frame comprises a plurality of first regions, and generating the motion compensated history of the input frame comprises:
for each first region of the input frame, searching for at least one second region most relevant to the corresponding first region in the history of the input frame; and
generating the motion compensated history of the input frame based on a correspondence between each first region and the corresponding at least one second region.

14. The apparatus according to claim 3, wherein searching for the at least one second region is based on a top-k search of a maximum of k regions in the history of the input frame for the at least one second region most relevant to each first region.

15. The apparatus according to claim 2, wherein restoring at least one degradation contained in the input frame further comprises:
assigning weights to the motion compensated history of the input frame, based on an importance of a corresponding frame in the motion compensated history of the input frame to the input frame; and
calculating a weighted sum of the motion compensated history of the input frame for generating the output frame.

16. The apparatus according to claim 1, wherein the machine learning model is based on a U-Net structure.

17. The apparatus according to claim 1, wherein each of the at least one encoder comprises at least one feed forward network (FFN).

18. The apparatus according to claim 1, wherein the first predetermined number is 3.

19. The apparatus according to claim 1, wherein the machine learning model is trained though operations comprising:
obtaining a training video;
dividing the training video into a plurality of clips, each clip comprising a second predetermined number of training frames;
processing two or more clips using two or more decoders in parallel; and
resetting a state of each decoder once the processing of a corresponding clip is completed.

20. The apparatus according to claim 1, wherein the non-transitory computer-readable storage medium records thereon computer-readable instructions that, when executed by the at least one processor, cause the apparatus to continuously processing each frame of the video for restoration without resetting a state of the at least one decoder.

21. One or more non-transitory computer-readable storage devices comprising computer-executable instructions for execution by at least one processor, wherein the instructions when executed by the at least one processor, cause the at least one processor to perform operations comprising:
obtaining an input frame from a video for restoration; and
processing the input frame to generate an output frame using a machine learning model, wherein the machine learning model is based on an encoder-decoder architecture comprising at least one memoryless encoder and at least one decoder, and each of the at least one memoryless encoder and the at least one decoder comprises one or more neural networks;
wherein processing the input frame to generate the output frame comprises:
processing the input frame using the at least one memoryless encoder to extract features from the input frame;
restoring at least one degradation contained in the input frame using the at least one decoder, based on the input frame and a history of the input frame, the history of the input frame comprising a sequence of frames of the video preceding the input frame of up to a first predetermined number; and
generating the output frame with restored degradation.
